(19) United States
(12) Patent Application Publication
(10) Pub. No.: US 2026/0098977 A1
(43) Pub. Date: Apr. 9, 2026

(54) SYSTEM AND METHOD FOR 3-D AND 4-D FULL WAVEFORM INVERSION USING PARTIAL VARIATION REGULARIZATION

(71) Applicant: Chevron U.S.A. Inc., San Ramon, CA (US)

(72) Inventors: John Kenneth WASHBOURNE, Houston, TX (US); Kenneth Paul BUBE, Seattle, WA (US); Shauna Kaye Oppert, Houston, TX (US)

(21) Appl. No.: 19/351,173

(22) Filed: Oct. 6, 2025

Related U.S. Application Data
(60) Provisional application No. 63/704,222, filed on Oct. 7, 2024.

(51) Int. Cl. G01V 1/34; G01V 1/30

(52) U.S. Cl. CPC G01V 1/345; G01V 1/308; G01V 2210/42

(57) ABSTRACT

A method is described for performing full waveform inversion with partial variation regularization on seismic data to generate the multi-dimensional map of physical properties of the earth's subsurface. The method must be executed by a computer system.

### CROSS-REFERENCE TO RELATED APPLICATIONS

This application claims the benefit of U.S. Provisional Application 63/704,222 filed Oct. 7, 2024.

### TECHNICAL FIELD

The disclosed embodiments relate generally to techniques for determining physical properties of the earth's subsurface based on seismic data. In particular, the disclosed embodiments describe a novel method for determining physical properties of the subsurface, and/or changes in the physical properties of the subsurface, using full waveform inversion of 3-D and/or 4-D seismic data.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their speed and direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. This process may include determining the material parameters of the subsurface formations (including velocities, densities, and anisotropy: physical properties that determine the speed and direction that seismic waves travel in the subsurface) in order to perform the imaging. Determining the material parameters may be done by a number of methods, such as semblance analysis, tomography, or full waveform inversion. Full waveform inversion (FWI) is a computationally expensive process. Improved seismic images from improved subsurface material parameters allow better interpretation of the locations of rock and fluid property changes. The ability to define the location of rock and fluid property changes in the subsurface is crucial to our ability to make the most appropriate choices for purchasing materials, operating safely, enhancing hydrocarbon recovery and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, designing production surveillance projects, preventing subsurface integrity issues by planning proper casing and cementation strategies and understanding out of zone injection, and selecting and purchasing appropriate completion and production equipment.

There exists a need for better material parameter models of the subsurface in order to determine locations of physical properties of subsurface, to be used in hydrocarbon exploration and production.

### SUMMARY

In accordance with some embodiments, a method is disclosed for performing full waveform inversion with partial variation regularization on seismic data to generate a multi-dimensional map of physical properties of the earth's subsurface. The multi-dimensional map may be used to perform seismic imaging. The multi-dimensional map may be used for interpretation of locations of physical properties in the subsurface.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example system for full waveform inversion using partial variation regularization;

FIG. 2 illustrates an example method for full waveform inversion using partial variation regularization;

FIG. 3 illustrates synthetic examples of performing an example method for full waveform inversion using partial variation regularization with different weights;

FIG. 4 illustrates terms contributing to an example method for simultaneous 4D seismic full waveform inversion using partial variation regularization;

FIG. 5 illustrates a field-analog synthetic example of performing an example method for simultaneous 4D seismic full waveform inversion using partial variation regularization and compares various alternative regularization types; and

FIG. 6 illustrates a field-analog synthetic example of performing an example method for simultaneous 4D seismic full waveform inversion using partial variation regularization and shows the results evolve with 20 iterations.

Like reference numerals refer to corresponding parts throughout the drawings.

### DETAILED DESCRIPTION OF EMBODIMENTS

Described below are methods, systems, and computer readable storage media that provide a manner of full waveform inversion. These embodiments are designed to be of particular use for recovering 3-D signal in 3-D seismic data and 4-D signal in 4-D seismic data in order to generate models of physical properties of the earth's subsurface. These embodiments used for 3-D FWI may, for example, improve recovery of low velocity zones that are otherwise extremely challenging to solve for. These embodiments used for 4-D FWI may, for example, delineate both the detectable overburden geomechanical changes in 4-D seismic, as well as the reservoir 4-D seismic changes in pressure, saturation, and strain/stress. In 4-D, these embodiments may lead to significant uplift in delineating true 4-D changes observed from even the very first frequency band, leading to a much more efficient algorithm for inversion. The models are multi-dimensional maps of the physical properties of the subsurface.

Conventional methods for estimating velocities and other physical properties in the earth's subsurface rely on ray-based algorithms based on high frequency asymptotic approximations. In recent years, full waveform inversion (FWI), based on waveform matching, has been widely used in velocity updating. Other material parameters, such as stiffness, anisotropy, and the like may also be determined by increasingly complex FWI methods. In seismic inversion, the physical properties of the subsurface medium are often discontinuous. Sharp velocity contrasts in the subsurface velocity model may affect the inversion results. Consequently, a regularization method can be introduced in the inversion process to improve its stability and performance. Full waveform inversion methods using total variation (TV) regularization have been developed, but these are very computationally expensive and tend to deliver blocky results that are not ideal for representing the earth's subsurface.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

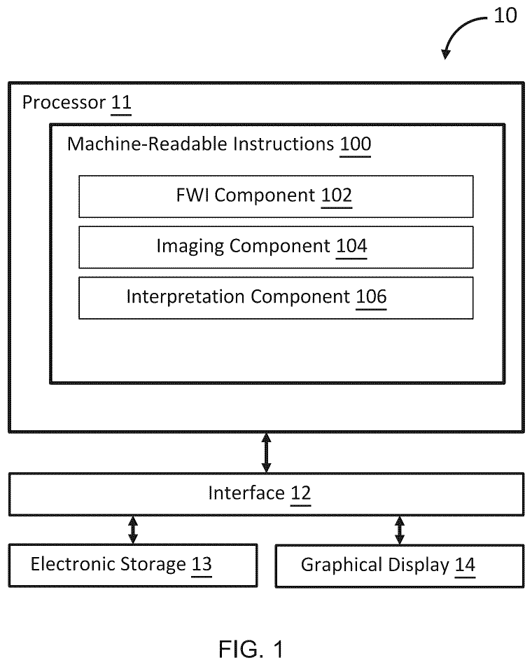

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. The processor 11 is configured to receive seismic data, perform full waveform inversion using partial variation regularization, and generate a model of the physical properties of the earth's subsurface. Processor 11 may also perform seismic imaging and interpretation based on the generated model of the physical properties of the subsurface.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to the input seismic data, and/or other information. For example, the electronic storage 13 may store information relating to output models of physical properties of the subsurface, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to models of the physical properties of the subsurface, seismic data, seismic images, and/or seismic interpretations, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate full waveform inversion with partial variation regularization. The machine-readable instructions 100 may include one or more computer program components. The machine-readable instructions 100 must include a full waveform inversion (FWI) component 102, and may also include an imaging component 104, an interpretation component 106, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for case of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the FWI component 102 may be configured to perform full waveform inversion using partial variation regularization. Partial variation regularization is a type of regularization of the iterative process of FWI in which a hybrid L1/L2 norm or similar norm is applied as a left preconditioner to a non-linear penalty on the magnitude of the spatial gradient of material parameters. This regularization penalty linearizes the hybrid norm and weights individual derivative penalties in each coordinate direction as a left preconditioner. The FWI component 102 generates a multi-dimensional map (or model) of physical material parameters of the subsurface, such as the seismic velocities, which delineate layers and/or geobodies within the subsurface.

The partial variation regularization is a simplified implementation of “total variation regularization.” The main idea of total variation regularization is to minimize the L1 norm of the magnitude of the gradient of velocity (+other material parameters). Instead of formally solving a total variation problem, the present invention implements the regularization with a Hybrid L1/L2 norm applied as a left preconditioner to a nonlinear penalty on the magnitude of the spatial gradient of material parameters. Partial variation essentially replaces the L1 norm used in Total Variation with a Hybrid norm or a similar norm such as the Huber norm or the Student's T distribution. In an embodiment, the method does not formally take the derivatives of this regularization operator, but instead linearizes the Hybrid norm as a left preconditioner and applies as it weights the individual components of the derivative penalties in each spatial direction. This approach is much cheaper to implement than optimization of a formal total variation regularization and has advantageous behaviors for target properties that are not blocky rectangular prisms or constant valued.

The linearization of the Hybrid norm as a left preconditioner can be done as follows. Define r; as the magnitude of the spatial gradient of material parameter at location i for model m, such that it collects contributions from all three derivative terms

$$\frac{\partial }{\partial x} , \frac{\partial }{\partial y} , and \frac{\partial }{\partial z} .$$

Define φ as the Hybrid norm of the partial variation regularization term. Define Lₕₜᵥ as the diagonal matrix of weights in the linearization of the Hybrid norm and (Lₕₜᵥ)ᵢᵢ is one element of that matrix. Finally, define a standard deviation as σ. The σ can be treated as a constant scalar related to the value of material parameter that causes the penalty to transition from L1 to L2. Smaller values for σ make L1 more aggressive, larger values for σ make the penalty behave like L2 regularization. The equations are:

$${r}_{i} = \sqrt{{( \frac{\partial }{\partial x} {m}_{i} )}^{2} + {( \frac{\partial }{\partial y} {m}_{i} )}^{2} + {( \frac{\partial }{\partial z} {m}_{i} )}^{2}}$$

$$ϕ = {\sum }_{i} 2 {σ}^{2} [ {( 1 + \frac{{r}_{i}^{2}}{{σ}^{2}} )}^{\frac{1}{2}} - 1 ]$$

$${( {L}_{htv} )}_{i i} = {( 1 + \frac{{r}_{i}^{2}}{{σ}^{2}} )}^{- \frac{1}{4}}$$

The next equations demonstrate how to linearize the nonlinear penalty. The penalty term driving the regularization is shown in the first equation below. Moving from the first equation to the second equation we linearize the Hybrid norm. When the updated model is represented as (m+δm), a non-zero right-hand-side for this nonlinear penalty term appears and is shown in the second equation below. Lₕₜᵥ is the diagonal matrix of weights in the linearization of the Hybrid norm and will appear three times (once for each coordinate direction) as a block diagonal matrix in the penalty. The scalar λ controls how strong the partial variation regularization is, allowing us to dial up or down the magnitude of the regularization term relative to the other terms we seem to optimize including for example data misfit.

$$λ {‖ [ \begin{matrix}\frac{\partial }{\partial x} \\ \frac{\partial }{\partial y} \\ \frac{\partial }{\partial z}\end{matrix} ] ( m + δ m ) ‖}_{h} \to [ \begin{matrix}0 \\ 0 \\ 0\end{matrix} ]$$

$$λ [ \begin{matrix}{L}_{h t v} & 0 & 0 \\ 0 & {L}_{h t v} & 0 \\ 0 & 0 & {L}_{h t v}\end{matrix} ] ( [ \begin{matrix}\frac{\partial }{\partial x} \\ \frac{\partial }{\partial y} \\ \frac{\partial }{\partial z}\end{matrix} ] δ m ) = − λ [ \begin{matrix}{L}_{h t v} & 0 & 0 \\ 0 & {L}_{h t v} & 0 \\ 0 & 0 & {L}_{h t v}\end{matrix} ] ( [ \begin{matrix}\frac{\partial }{\partial x} \\ \frac{\partial }{\partial y} \\ \frac{\partial }{\partial z}\end{matrix} ] m )$$

To implement the linearized penalty, the next step is to solve for the perturbation to the model that will minimize the partial variation penalty term. δm is the perturbation to the model defined as minus the gradient of the PV regularization term, and adding δm to m will minimize the penalty term applied to (δm+m). Thus the equation and its simplification can be written as

$$δ m = − {λ}^{2} {( [ \begin{matrix}{L}_{h t v} & 0 & 0 \\ 0 & {L}_{h t v} & 0 \\ 0 & 0 & {L}_{h t v}\end{matrix} ] [ \begin{matrix}\frac{\partial }{\partial x} \\ \frac{\partial }{\partial y} \\ \frac{\partial }{\partial z}\end{matrix} ] )}^{T} [ \begin{matrix}{L}_{h t v} & 0 & 0 \\ 0 & {L}_{h t v} & 0 \\ 0 & 0 & {L}_{h t v}\end{matrix} ] [ \begin{matrix}\frac{\partial }{\partial x} \\ \frac{\partial }{\partial y} \\ \frac{\partial }{\partial z}\end{matrix} ] m$$

$$δ m = − {λ}^{2} {[ \begin{matrix}\frac{\partial }{\partial x} \\ \frac{\partial }{\partial y} \\ \frac{\partial }{\partial z}\end{matrix} ]}^{T} [ \begin{matrix}{L}_{h t v}^{2} & 0 & 0 \\ 0 & {L}_{h t v}^{2} & 0 \\ 0 & 0 & {L}_{h t v}^{2}\end{matrix} ] [ \begin{matrix}\frac{\partial }{\partial x} \\ \frac{\partial }{\partial y} \\ \frac{\partial }{\partial z}\end{matrix} ] m$$

Although the embodiment above describes the method using the Hybrid norm, those of skill in the art will appreciate that in other embodiments any function with similar properties or behavior, such as the Huber norm or the Student's T distribution, could be used. The description using the Hybrid norm is not meant to be limiting, the scope of the present invention includes any function with similar properties or behavior.

The imaging component 104 may be configured to perform seismic imaging of the seismic data based on the model of physical properties of the subsurface generated by FWI component 102 to generate a seismic image of the subsurface. The imaging component 104 may use any seismic imaging, such as Gaussian beam imaging, reverse time migration, and the like.

The interpretation component 106 may be configured to allow interpretation of the seismic image from imaging component 104 itself or in combination with the model of physical properties of the subsurface from FWI component 102. For example, the model of physical properties may be overlaid on the seismic image and shown on the graphical display 14. This will allow improved planning for hydrocarbon well placement and hydrocarbon production.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

Although the description above describes the implementation in 3D, those of skill in the art will understand that the process can also be performed in 2D and in 4D. The implementation can be optimized using regularization weight λ and gradient standard deviation σ. The scaling of these is dependent on the discretization of the model, and as such needs to be optimized for each frequency band. This may be user-specified or automated using a power method that can be used to estimate the “operator norm” of operators. If you have D (derivative operator) and it's adjoint D′, we can get the largest eigenvector of D (and the associated eigenvalue) by Rayleigh iteration.
1. Initialize vector x in domain of D with random values
2. Apply D′D to x
3. Normalize resulting vector and return to (1)
4. Stop when x stops changing

By way of example and not limitation, the process above may be coded as:

```
x = rand(Float32,nz,nx)
for iter = 1:100
  x /= norm(x)
  x = D′ * D * x
end
```

at the end, norm (x) is the square of the operator norm of D. If you apply this for the derivative operator D and the Jacobian operator for FWI, you can scale the two relatively.

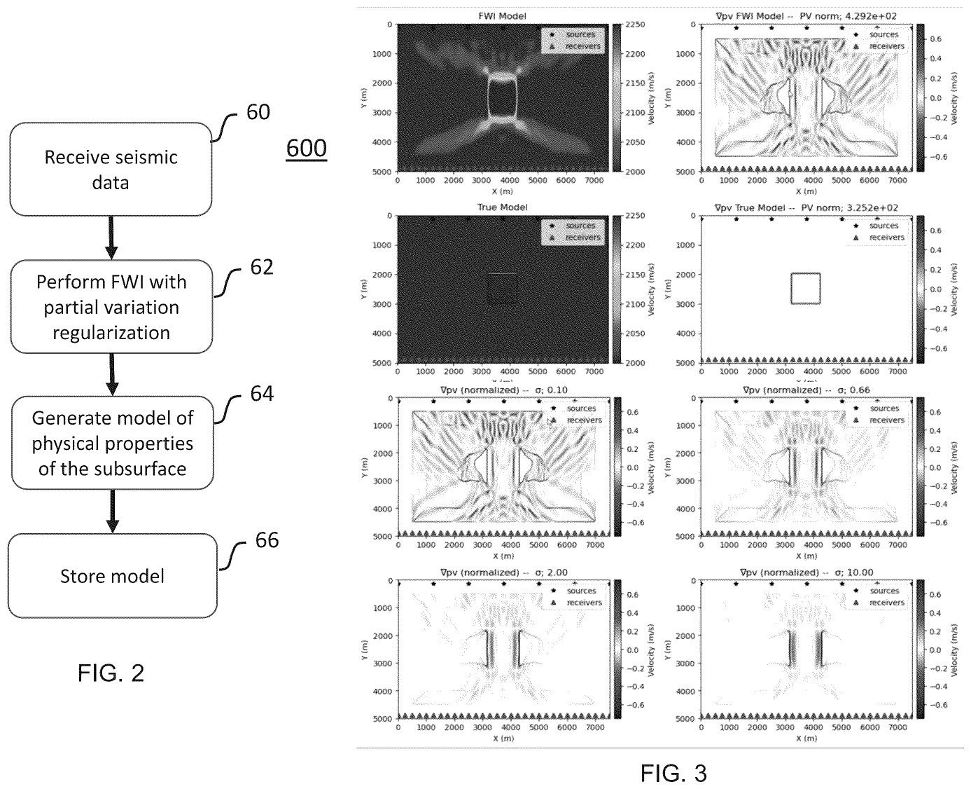

FIG. 2 illustrates an example process 600 for full waveform inversion using partial variation regularization. At operation 60, process 600 receives seismic data. The seismic data is provided to operation 62, which performs FWI with partial variation regularization. FWI with partial variation regularization is up to 5 times faster than FWI with total variation regularization, making it possible to use on field data in a production setting. Operation 64 generates models of the physical properties of the subsurface that are accurate even in the presence of sharp velocity contrasts. These models are stored at operation 66 for possible use in seismic imaging and/or interpretation.

FIG. 3 illustrates synthetic examples of performing process 600. In these examples, different σ values have been used. The upper 4 panels of FIG. 3 illustrate how artifacts in an FWI model (spurious structure away from the known central rectangular model change) can have large contributions to the partial variation regularization penalty. The lower 4 panels of FIG. 3 illustrate how changing the σ parameter changes the impact of the partial variation regularization penalty.

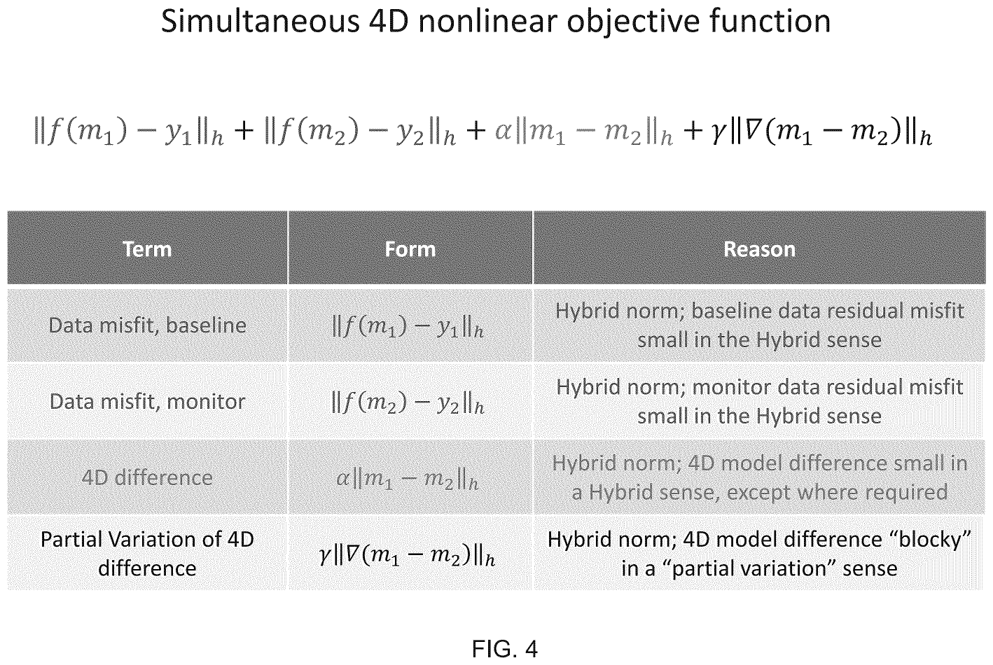

FIG. 4 shows a table with contributions and optimization goals for various terms of an example method for simultaneous 4D seismic full waveform inversion using partial variation regularization, process 600 for 4D FWI.

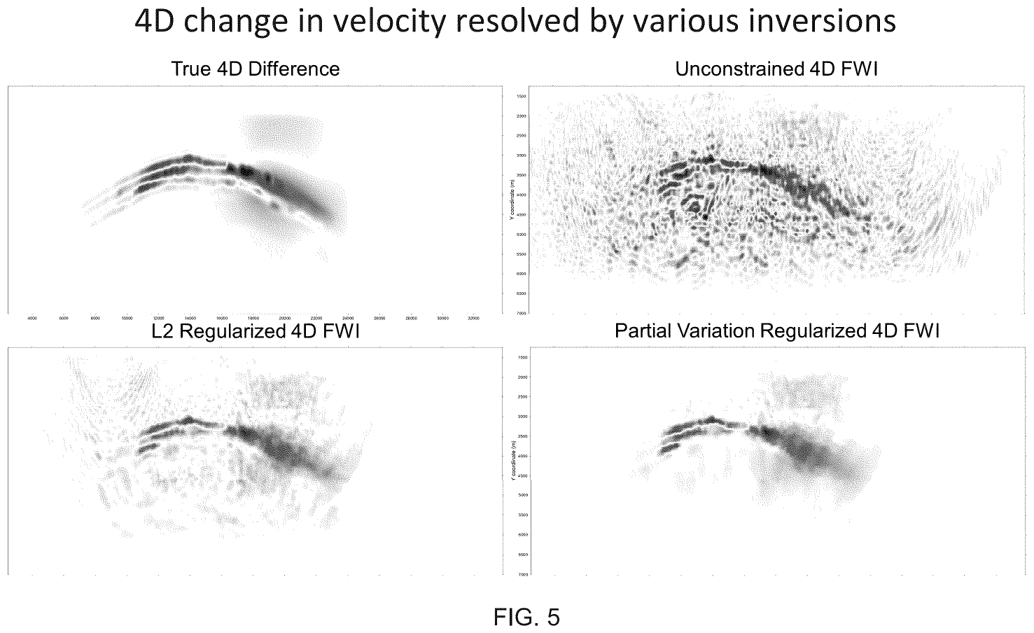

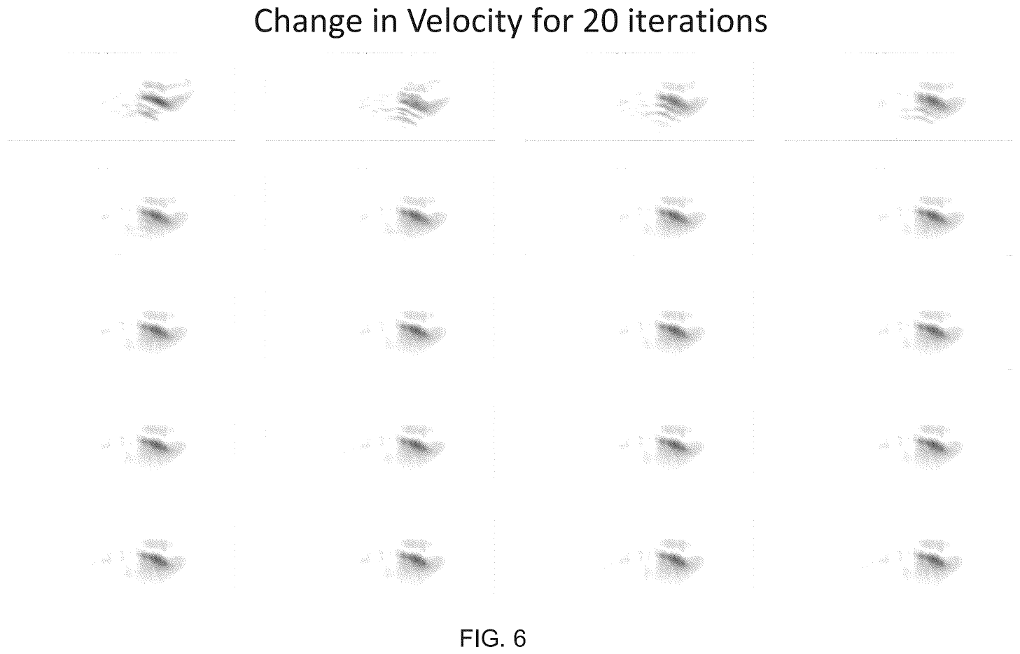

FIGS. 5 and 6 demonstrate results from a synthetic example for an example method for simultaneous 4D seismic full waveform inversion using partial variation regularization, process 600 for 4D FWI. FIG. 5 demonstrates how this example achieves reduced noise in the inverted result for 4D change in velocity over that obtained both with the conventional L2 regularization and no regularization (unconstrained). Geomechanical, low spatial frequency differences are resolved as well as reservoir scale, higher spatial frequency changes in velocity. FIG. 6 shows how the results evolve for the first 20 iterations of this process, and that reduced noise and simplification of the 4D difference model is achieved in the inverted change in velocity in each of the 20 iterations of 4D FWI. This styling of the model change into smooth blocky features is a key result of the use of partial variation regularization in process 600 for 4D simultaneous FWI.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of generating a multi-dimensional map of physical properties of earth's subsurface, comprising:
a. receiving seismic data representative of the earth's subsurface; and
b. performing full waveform inversion with partial variation regularization on the seismic data to generate the multi-dimensional map of physical properties of the earth's subsurface.

2. The method of claim 1 further comprising performing seismic imaging of the seismic data using the multi-dimensional map of physical properties of the earth's subsurface to generate a seismic image.

3. The method of claim 2 further comprising overlaying the multi-dimensional map of physical properties of the earth's subsurface onto the seismic image to perform seismic interpretation.

4. The method of claim 1 further comprising using the multi-dimensional map of physical properties of the earth's subsurface for seismic interpretation.

5. The method of claim 1 wherein the partial variation regularization uses one of a Hybrid norm, a Huber norm, or a Student's T distribution.

6. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive seismic data representative of the earth's subsurface; and
b. perform full waveform inversion with partial variation regularization on the seismic data to generate the multi-dimensional map of physical properties of the earth's subsurface.

7. The computer system of claim 6 further including instructions that when executed by the one or more processors cause the system to perform seismic imaging of the seismic data using the multi-dimensional map of physical properties of the earth's subsurface to generate a seismic image.

8. The computer system of claim 7 further including instructions that when executed by the one or more processors cause the system to overlay the multi-dimensional map of physical properties of the earth's subsurface onto the seismic image to perform seismic interpretation.

9. The computer system of claim 6 further including instructions that when executed by the one or more processors cause the system to use the multi-dimensional map of physical properties of the earth's subsurface for seismic interpretation.

10. The computer system of claim 6 wherein the partial variation regularization uses one of a Hybrid norm, a Huber norm, or a Student's T distribution.
